(19) United States
(12) Patent Application Publication
(10) Pub. No.: US 2015/0160837 A1
(43) Pub. Date: Jun. 11, 2015

(54) METHOD AND DEVICE FOR PROCESSING AND DISPLAYING A PLURALITY OF IMAGES

(71) Applicant: SAMSUNG ELECTRONICS CO., LTD., Gyeonggi-do (KR)

(72) Inventor: Hyunsoo KIM, Gyeonggi-do (KR)

(73) Assignee: SAMSUNG ELECTRONICS CO., LTD.

(21) Appl. No.: 14/565,026

(22) Filed: Dec. 9, 2014

(30) Foreign Application Priority Data
Dec. 9, 2013 (KR) 10-2013-0152484

(51) Int. Cl. G06F 3/0484; G06F 9/44; G06F 3/0481; G06T 7/60

(52) U.S. Cl. CPC G06F 3/04842; G06T 7/602; G06F 9/4446; G06F 3/0481

(57) ABSTRACT

A method and a device for processing a first image and a second image respectively obtained from first and second image sensors to output in a screen are provided. The method includes recognizing first disposition information of at least one object included in the first image output through a main window; identifying disposition information of a sub-window outputting the second image; and generating optimum disposition information of the first image by comparing the first disposition information of the at least one object and the disposition information of the sub-window with predetermined basic disposition information.

### PRIORITY

This application claims priority under 35 U.S.C. §119(a) to a Korean Patent Application filed on Dec. 9, 2013 in the Korean Intellectual Property Office and assigned Serial No. 10-2013-0152484, the entire content of which is incorporated herein by reference.

### BACKGROUND OF THE INVENTION

1. Field of the Invention

The present invention generally relates to a method and a device for processing a plurality of images so that the images are output through a multi-window view with optimum conditions.

2. Description of the Related Art

An electronic device such as a portable terminal can exchange information with a user through various interfaces. Various functions can be performed by utilizing input means of the electronic device, such as a touch screen enabling an input of an object being output through a display device, microphone for receiving a user voice, and a camera for collecting an image.

Various functions are developed for a camera as an input means. According to the recent development in communication technology, the data transmission rate has been increased, and thereby a video telephone communication function can be provided in real time. For example, a face of called party transmitted through a network can be displayed in a screen of portable terminal and a face of user capture by a camera can be displayed in a sub-window of the screen.

Furthermore, most of the recent portable terminals include a main camera for capturing an object image and a sub-camera for capturing a user image. That is, a plurality of cameras can be installed in an electronic device, and a function of simultaneously capturing images through the plurality of cameras can be provided. For example, when the user wants to take a photo in a trip, a view captured by the main camera and a user face captured by the sub-camera can be stored as one image.

Images captured by different cameras (namely, image sensors) can be simultaneously output in a screen. Each image can be output in separate windows. In order to obtain a good photo (image), it is important to capture objects in the corresponding image with optimum conditions. When outputting images in a multi-window, an image being output through the main screen can be covered or influenced by another image output through the sub-window. In this case, a function of guiding the user is inevitably necessary so as to capture each image in an optimum condition.

When outputting another image through the sub-window at the same time of outputting an image through the main screen, the image output through the main screen can be interfered with by the image output through the sub-window, and thereby the user can have a problem in obtaining an optimum image.

### SUMMARY OF THE INVENTION

The present invention has been made to address at least the above mentioned problems and/or disadvantages and to provide at least advantages described below. Accordingly, an aspect of the present invention is to provide a user with a function of obtaining an optimum image and a function of obtaining an image of a main screen by considering the location and size of a sub-window, especially when outputting images in a multi-window screen.

Another aspect of the present invention is to provide an optimum screen for a user and a called party and to extract a user voice accurately when performing a video telephone conversation function.

In accordance with an aspect of the present invention, a method for processing and outputting a first image and a second image respectively obtained from first and second image sensors in a screen is provided. The method includes recognizing first disposition information of at least one object included in the first image output through a main window, identifying disposition information of a sub-window outputting the second image, and generating optimum disposition information of the first image by comparing the first disposition information of the at least one object and the disposition information of the sub-window with predetermined basic disposition information.

In accordance with another aspect of the present invention, a device for processing an image is provided. The device includes a first image recognizer configured to identify first disposition information of at least one object included in a first image output through a main windows and disposition information of a sub-window, a first image processor configured to generate optimum disposition information by comparing the first disposition information of the at least one object included in the first image and the disposition information of the sub-window with predetermined basic disposition information, a second image recognizer configured to identify second disposition information of at least one object included in a second image output through the sub-window, and a second image processor configured to generate optimum disposition information of the second image by comparing the second disposition information of the object included in the second image with the predetermined basic disposition information. The first and second images are obtained respectively by first and second image sensors.

### BRIEF DESCRIPTION OF THE DRAWINGS

The above and other aspects, features, and advantages of certain embodiment of the present invention will be more apparent from the following description, taken in conjunction with the accompanying drawings, in which:

FIG. 1 illustrates an example of image output in an electronic device including an image processing device according to an embodiment of the present invention;

FIG. 2 is a block diagram illustrating a configuration of image processing device according to an embodiment of the present invention;

FIG. 3A is a flow chart illustrating detailed operations of the main screen output controller of FIG. 2;

FIG. 3B is a flow chart illustrating a procedure of generating optimum disposition information of FIG. 3A;

FIG. 4 is a flow chart illustrating detailed operations of the sub-screen output controller of FIG. 2;

FIG. 5 is a screen example illustrating an operation of image processing device according to an embodiment of the present invention;

FIG. 6 is a block diagram illustrating a configuration of electronic device including an image processing device according to an embodiment of the present invention; and

FIG. 7 is a flow chart illustrating a procedure of video telephone conversation in an electronic device according to an embodiment of the present invention.

### DETAILED DESCRIPTION OF EMBODIMENTS OF THE PRESENT INVENTION

Hereinafter, embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

For the same reasons, some components in the accompanying drawings are emphasized, omitted, or schematically illustrated, and the size of each component does not fully reflect the actual size. Therefore, the present invention is not limited to the relative sizes and distances illustrated in the accompanying drawings.

In the detailed description of the present invention, an expression “or” includes one of listed words and their combinations. For example, “A or B” can include A, B, or both A and B.

In the detailed description of the present invention, expressions such as “first” and “second” can modify various components of the present invention but do not limit the corresponding components. For example, the above expressions do not limit the order and/or importance of the corresponding components. The above expressions can be used to distinguish one component from another component. For example, both a first user device and a second user device are the same user devices but indicate separate user devices. For example, within the spirit and scope of the present invention, a first component can be called second component, and similarly, the second component can be called first component.

When describing that a component is “connected” or “accessed” to another component, the component could be directly connected or accessed to the other component, however, it should be understood that the other component also could exist between them. On the other hand, if it is described that a component is “directly connected” or “directly accessed” to another component, it should be understood that any other component does not exist between them.

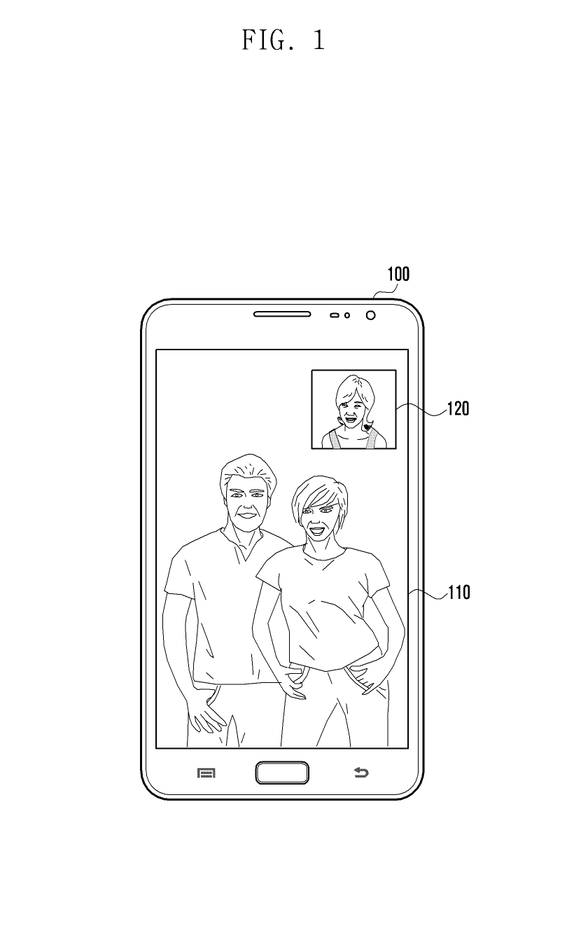

FIG. 1 illustrates an example of image output in an electronic device including an image processing device according to an embodiment of the present invention.

The electronic device 100 according to an embodiment of the present invention outputs images through a screen by processing with an image processor. When outputting a plurality of images (for example, two images) through a screen, the electronic device 100 outputs each image in separated screens. For example, a first image is output through a main screen 110 and a second image is output through a sub-window by configuring a Picture In Picture (PIP) structure on the main screen 110. Here, the first and second images may be obtained from different image sensors. For example, one is an image obtained by an image sensor installed in a camera of the electronic device 100 and the other one is an image obtained by an image sensor installed in a camera of another electronic device and transmitted to the electronic device 100 through a network. Alternatively, both the first and second images may be captured by a plurality of cameras installed in the electronic device 100.

For example, an output screen of the electronic device 100 can display an image obtained by an image sensor of a main camera (not shown) in the main screen 110 and an image obtained by an image sensor of a sub-camera in a sub-screen window 120. According to another embodiment of the present invention, when performing a video telephone conversation function by using the electronic device 100, an image of a called party transmitted through a network can be output through the main screen 110 and an image of a user obtained by a camera installed in the electronic device 100 can be output through the sub-screen window 120.

The image output through the screen of the electronic device 100 includes various objects, such as a human face. In order to obtain an optimum image of the corresponding object, an image sensor may be installed in the electronic device 100 and an image processor may be set with basic disposition information so that the optimum image of the object can be obtained. Accordingly, the image processor can generate optimum disposition information by comparing the current object disposition information of an identified image with predetermined basic disposition information so that a user can obtain an optimum image. Herein, optimum disposition information provides a favored disposition of the image(s) by the user, to optimize the image viewing by enabling an adjusted view of the images the user desires to view on the display. Furthermore, in case of outputting an image through the main screen 110, the image processor according to the embodiment of the present invention can generate optimum disposition information by considering the sub-screen window 120 as well as objects included in the image of main screen 110, because some objects in the image can be overlapped by the sub-screen window 120.

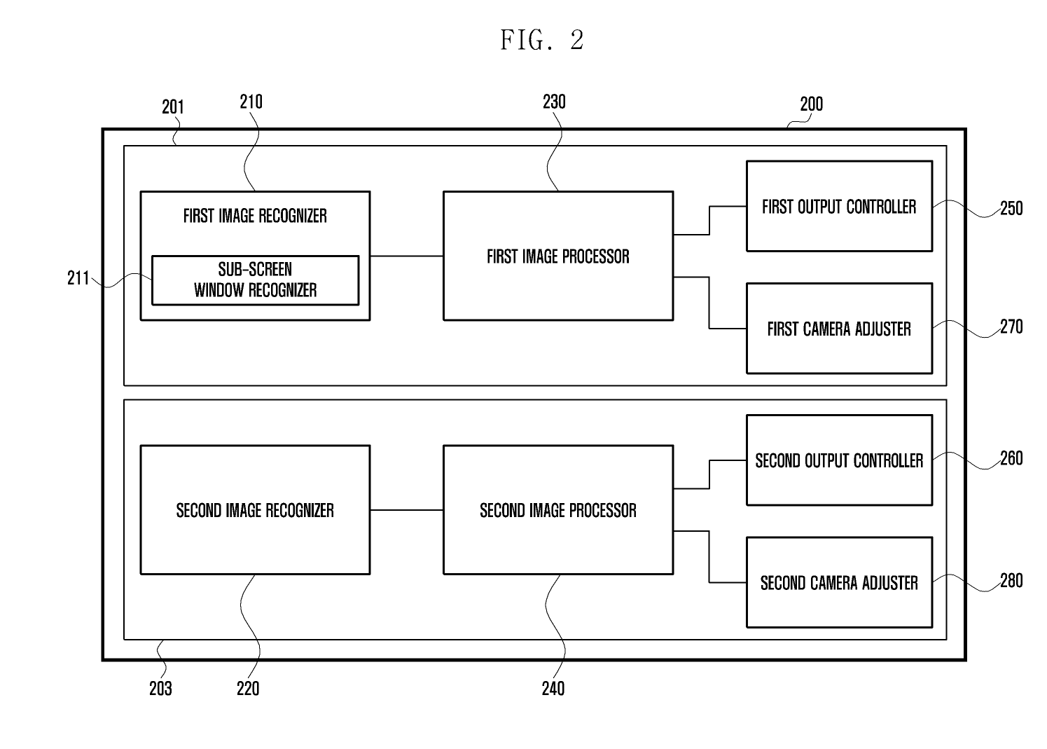

FIG. 2 is a block diagram illustrating a configuration of image processing device according to an embodiment of the present invention.

The image processor 200 according to the embodiment of the present invention includes a main screen output controller 201 and a sub-screen output controller 203.

The main screen output controller 201 recognizes a first image output through a main screen, and generates optimum disposition information so that an optimum image for the first image can be obtained. If a sub-screen window is included in the main screen, the main screen output controller 201 recognizes the sub-screen window and generates optimum disposition information. The main screen output controller 201 provides various options so that a user can obtain an optimum image by using the optimum disposition information, i.e., relating to a favored disposition of the image(s) by the user, to optimize the image viewing. For example, the first image is obtained through a main camera in the electronic device 100 including the image processor 200, or obtained by an image sensor of another electronic device and transmitted through a network.

The main screen output controller 201 includes a first image recognizer 210 and a first image processor 230.

The first image recognizer 210 identifies disposition information of at least one object included in the obtained first image. The disposition information includes a type, size, location, number, occupation ratio, and distribution of object. That is, the first image recognizer 210 identifies which disposition objects are configured in the first image output through the current main screen.

For example, if the object is a human face, the first image recognizer 210 uses a face detection technology based on the image recognition or processes face recognition by comparing a detected face with a user database in order to identify existence of persons in an image captured by an image sensor. Further, the existence of persons can be identified by using an omega detector which detects a human shoulder from an input image from these identifications.

Specifically, according to an embodiment of the present invention, the first image recognizer 210 searches a face with a face detector if an image is input, combines the result from the face detector with the result from the omega detector, and traces existence and location of a user. The omega detector identifies existence of persons from a certain image by using a pattern from a human head to shoulders, and can detect a side view or rear view which the face detector can not detect.

In the case of omega detector, because information up to a shoulder line is required, some figures can not be detected with the omega detector if the distance between the electronic device and a face is too close. However, the omega detector can help a user in composing to obtain an optimum image based on the existence location and shape of persons, when a detected image is a portion of head, side view, or rear view which can not be detected by the face detector.

If the result detected by the omega detector is not identical to the result detected by the face detector, the result detected by the face detector can be selected by identifying whether the detected areas are overlapped and if the detected image is of the same person, because the result detected by the face detector gives a more precise location with higher reliability.

According to an embodiment of the present invention, the first image recognizer 210 detects objects such as a user's face from a screen, and obtains object disposition information such as a type, size, number, occupation ratio, and distribution of the detected objects. The occupation ratio signifies, for instance, the ratio of the area occupied by the detected objects to the entire screen area. If the face detector and the omega detector are used for obtaining the object disposition information, improved detection performance can be secured by combining a face detected by the face detector and a head area detected by the omega detector. Further, a tracing function is applied when a person is not detected, which can be also applied to continuous processing of images.

For example, when two faces are detected by the face detector and the omega detector, the object disposition information includes sizes and locations of the two detected faces, occupation ratio in a screen, and distribution information of the whole screen configuration.

The first image recognizer 210 further includes a sub-screen window recognizer 211. If the sub-screen window influences the first image output through the main screen, for example, if the sub-screen window is output on the main screen in a PIP structure, the sub-screen window recognizer 211 plays a role of identifying disposition information of the sub-screen window. That is, if the sub-screen window exists on the main screen, the sub-screen window recognizer 211 identifies disposition information such as a location and size of the sub-screen window.

The first image processor 230 generates optimum disposition information by receiving object disposition information of the first image and disposition information of the sub-screen window. That is, the first image processor 230 generates optimum disposition information by considering objects of the first image configuring the screen and disposition information of the sub-screen window so that a user can obtain an optimum screen.

Basic disposition information is preset in the first image processor 230 in order to generate the optimum disposition information. For example, if existence of user and distribution of objects is known by using the face or head detector, the basic disposition information required for identifying an optimum image is set as listed in Table 1.

TABLE 1

| Condition for obtaining an optimum image | | Corresponding basic disposition information |
|---|---|---|
| Head Room | Should not be too | Apply single parameter regardless of condition |
| (space between | wide | or mode |
| top of human | | Apply differentiated parameters according to |
| head and upper | | size of face, number of detection, and |
| edge of photo) | | photographing mode |
| Distance to | The closer, the better | Apply parameter by checking number of |
| person | photo | detected faces and size of head |
| Tri-sectional | Head or face should | In case of more than one person: |
| technique/Use | be located within | Use distribution of detected faces |
| dynamic and | boundary of | Even distribution: do not apply |
| symmetric | predetermined basic | High density area exist: apply |
| composition | area | (set composition to high density area) |
| | | In case of one person: |
| | | Apply if movement information is detected |
| | | from other than basic area (based on center of |
| | | screen if no movement information detected) |

The procedure of generating optimum disposition information according to the basic disposition information by the first image processor 230 is as follows. Initially, a face or head area is detected by the face detector and the omega detector. A high density area is identified based on the location and size information of detected users' face or head, and the optimum disposition information is generated so that the high density area is located in a predetermined area if a density area with a density opposite to that of the high density area exists. If the distribution of density is even, the image is identified as a good image. Parameters used for the basic disposition information includes information such as a head room, tri-sectional technique/dynamic symmetric structure, and size and location of head.

According to an embodiment of the present invention, an acceptable face size (from minimum size to maximum size) as the basic disposition information is important for obtaining an optimum image. The minimum size is necessary for selecting a photo or image which should not be taken, and the maximum size is necessary for reducing a detection area and testing a parameter conversion related to the performance of a detector. Further, detection of skin color may be necessary to detect a cutoff face.

The first image processor 230 according to an embodiment of the present invention generates optimum disposition information by applying different basic disposition information according to each mode, and identifies whether the electronic device is currently in a personal video telephone conversation mode or a group video telephone conversation mode when performing a video telephone conversation function.

For example, the personal video telephone conversation mode is identified if the result of detecting persons is a single detected person, and the group video telephone conversation mode is identified if the result of detecting persons is multiple (for example, 2 or 3 persons) detected persons. The telephone conversation mode may be identified according to a predetermined condition and a specific basic screen (For example, detected faces/heads are scattered out of a predetermined range, or a person located close to the center of a specific basic screen).

According to an embodiment of the present invention, basic disposition information preset in a video telephone conversation mode is listed in Table 2.

TABLE 2

| Condition for obtain- | |
|---|---|
| ing an optimum image | Corresponding basic disposition information |
| Face/head should not | No face or head detected within 20 pixels from |
| be overlapped by | upper/left/right boundaries. |
| boundary. | When sum of face/head size is greater than |
| | 10000 pixels: no face detected within 20 pixels |
| | from lower boundary. |
| | When sum of face/head size is less than 10000 |
| | pixels: no face detected within 60 pixels from |
| | lower boundary. |
| If 1 face/head | Center of face/head horizontally located in ⅓ |
| detected: locate | area of photo center. |
| in center. | Center of face/head vertically located in ⅓ |
| | area of photo center. |
| If more than 1 face | Detected face/head should not be located only |
| or head detected: | in 60% area from left/right boundary |
| locate with proper | Average center of detected faces/heads should |
| size and even | be horizontally located in ⅓ area of photo |
| distribution | center. |
| | Maximum distance between faces/heads should |
| | be less than ⅓ screen width. |
| Detected face should | Should satisfy condition of skin color in YCbCr/ |
| satisfy condition of | RGB domain. |
| skin color, locate | |
| with even distribution | |

According to an embodiment of the present invention, in a procedure of obtaining an image such as a video telephone conversation, object disposition information is generated by calculating density (or distribution) of persons located in a screen according to the number, size, location, and occupation ratio of human faces detected by the face detector and omega detector, and optimum disposition information is generated by comparing the detected object disposition information with the basic disposition information listed in Table 2.

The first image processor 230 according to an embodiment of the present invention generates optimum disposition information by considering not only the image being obtained (i.e., object disposition information of the first image) but also disposition information of the sub-screen window.

For example, the first image processor 230 identifies whether objects included in the first image are normally output by using sub-screen window disposition information such as a size and location of sub-screen window. For example, an object of human face/head is included in the image and such an object is covered by the sub-screen window. The first image processor 230 generates optimum disposition information so that such coverage is eliminated and the sub-screen window does not cover the human face/head. As another example, when a plurality of human faces/heads is included in an output image and a portion of the human faces/heads is covered by the sub-screen window, the first image processor 230 generates optimum disposition information by excluding faces/heads of persons covered by the sub-screen window and by using disposition information of faces/heads of the remaining persons.

According to an embodiment of the present invention, when images captured by a main camera and a sub-camera of the electronic device are output through a main screen and a sub-screen, the optimum disposition information is generated by considering correlation between movements of the main camera and the sub-camera.

The generated optimum disposition information may include disposition information for adjusting objects included in the image and may further include disposition information for adjusting the location and size of the sub-screen window.

The main screen output controller 201 further includes a first output controller 250 and a first camera adjuster 270 in order to provide a user with various options so that the user can obtain an optimum image by using the optimum disposition information.

According to various embodiments of the present invention, a method for re-adjusting a screen based on the optimum disposition information is used so that a screen matching closest with the basic disposition information can be output.

As an example of re-adjusting a screen, a method for controlling the main camera is performed through the first camera adjuster 270 by moving the main camera to a desired direction of output screen, if the electronic device is equipped with a physically movable camera. If physical movement of camera is unavailable as in general mobile phones, a method of guiding a user with a cursor on a screen or a voice may be used so that the user can change the direction of main camera through the first output controller 250.

In an embodiment of the present invention, the following operations are performed to obtain an optimum image in a video telephone conversation.

For example, if the camera of terminal is movable (for example, by installing a motor), the first camera adjuster 270 controls the movement of camera based on the optimum disposition information. The main screen output controller 201 performs re-measurement of face detector and omega detector for an image obtained after the movement of camera.

Alternatively, a zooming-in function is performed in the obtained image through first output controller 250 or a user moves the terminal camera to a desired direction or location in order to obtain a better screen image by using a guide for terminal movement (for example, by displaying an arrow mark on the screen). If an object included in the first image obtained by the first image recognizer 210 is covered, the optimum disposition information includes adjustment information of the sub-screen window so that the object is not covered by the sub-screen window. In this case, the location or size of the sub-screen window is automatically adjusted based on the optimum disposition information.

If the terminal is movable by installing a robot having a support table or wheel, not only the camera but also the terminal itself can move, and thereby a user can control the movement of terminal with a remote controller. In this case, a guide for directing the movement of terminal is displayed in the direction of re-configuring the screen so that the above condition is satisfied.

The sub-screen output controller 203 generates optimum disposition information by recognizing a second image output through a sub-screen window so that an optimum image for the second image can be obtained. The sub-screen output controller 203 provides various options so that a user can obtain an optimum image by using the optimum disposition information. For example, the second image is obtained by an image sensor of sub-camera installed in the electronic device 100 having an image processor 200 or obtained by an image sensor of another electronic device and transmitted through a network.

The sub-screen output controller 203 includes a second image recognizer 220, second image processor 240, second output controller 260, and second camera adjuster 280, similarly to those of the main screen output controller 201.

The function of the second image recognizer 220 is similar to that of the first image recognizer 210. The second image recognizer 220 identifies disposition information of at least one object included in an obtained second image. The disposition information includes information of at least one of a type, size, location, number, occupation ratio, and distribution of objects. That is, the second image recognizer 220 identifies which disposition objects configuring the second images are output through the current sub-screen.

The second image processor 240 generates optimum disposition information by receiving object disposition information of the second image. That is, the second image processor 240 generates optimum disposition information enabling the user to view an optimum screen by considering the objects of second image configuring the screen. More detailed basic disposition information and optimum disposition information are similar to those of the first image processor 230 previously described. However, the second image processor 230 generates optimum disposition information without considering the disposition information of the sub-screen window, which is different from the first image processor.

According to an embodiment of the present invention, if images captured by a main camera and a sub-camera of the electronic device are output respectively through the main screen and the sub-screen window, the optimum disposition information is generated by considering a correlation between the main camera and the sub-camera.

The second output controller 260 and the second camera adjuster 280 according to an embodiment of the present invention re-adjust a screen so that the screen matching closest with the basic disposition information can be output based on the optimum disposition information. As an example of re-adjusting a screen, if the electronic device is equipped with a physically movable camera, the movement of sub-camera is controlled through the second camera adjuster 280 by moving the sub-camera in a desired direction of screen. Alternatively, a method of guiding a user with a cursor on a screen or a voice is used so that a user can change the direction of sub-camera through the second output controller 260.

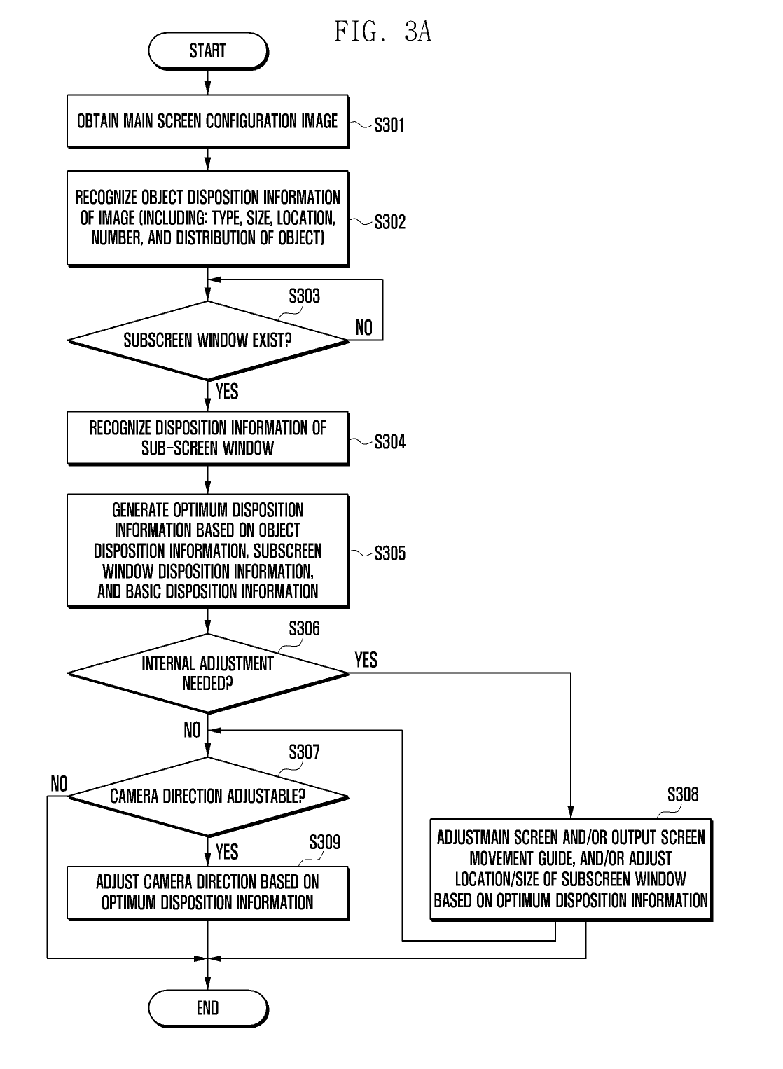

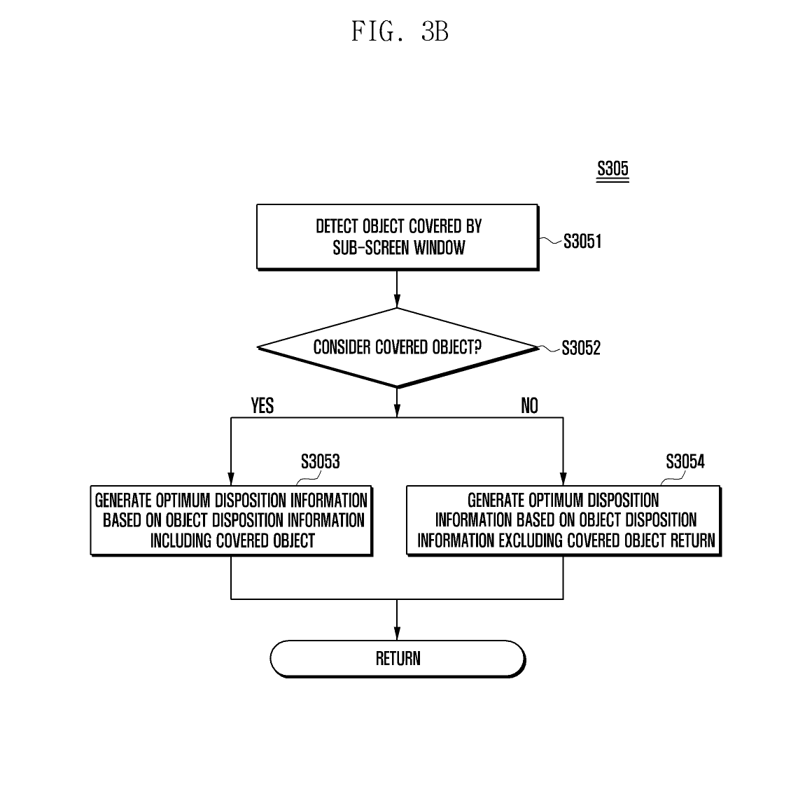

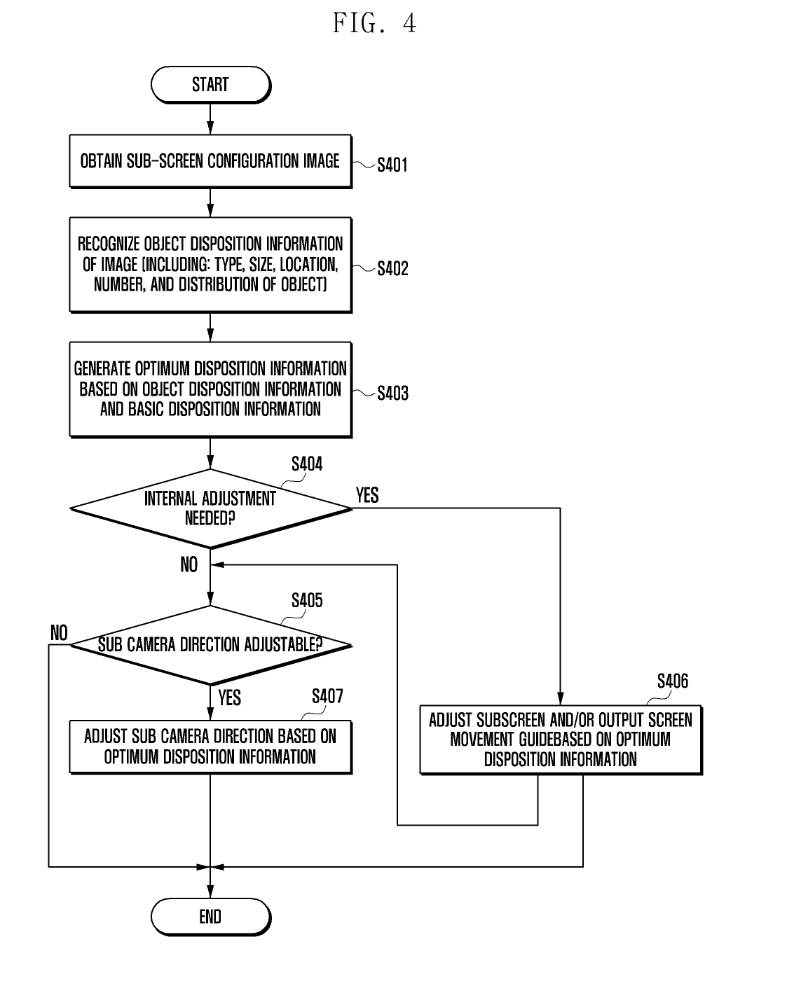

FIGS. 3A, 3B, and 4 are flow charts illustrating detailed operations of main screen output controller 201 and sub-screen output controller 203.

Referring to FIGS. 3A and 3B, the main screen output controller 201 obtains an image configuring a main screen at step S301, and identifies or recognizes object disposition information for the image such as a type, size, location, number, and distribution of objects at step S302. The main screen output controller 201 identifies whether a sub-screen window is included in the main screen at step S303, and if the sub-screen windows is included in the main screen, disposition information of the sub-screen window (for example, location and size of the sub-screen window) is identified or recognized at step S304. If the object disposition information and the disposition information of sub-screen window are identified or recognized, optimum disposition information for providing a user with an optimum image is generated by comparing the identified or recognized information with predetermined basic disposition information at step S305. The step S305 may include detailed steps as shown in FIG. 3B. Referring to FIG. 3B, an object covered by the sub-screen window is identified, detected or extracted from the objects output through the main screen based on the object disposition information at step S3051. It is determined whether to generate the optimum disposition information by considering the covered object or not at step S3052. This may be predetermined or selected according to a user input. Generation of optimum disposition information by considering the covered object means generating the optimum disposition information so that the object is not covered by the sub-screen window. If it is determined that the covered object is considered, the optimum disposition information is generated, by considering the object disposition information including the covered object, together with the sub-screen window disposition information and the basic disposition information at step S3053. Here, the optimum disposition information includes information for adjusting the main screen and information for adjusting the location and/or size of the sub-screen window covering the object. Alternatively, if it is determined that the covered object is not considered, the optimum disposition information is generated, by considering object disposition information excluding the covered object, together with the sub-screen window disposition information and the basic disposition information at step S3054.

Referring back to FIG. 3A, if the optimum disposition information is generated, it is identified whether an internal adjustment through the implementation of software is needed at step 306. If it is determined that an internal adjustment is needed, the main screen is adjusted based on the generated optimum disposition information by the internal adjustment (for example, a zooming-in function), or a guide for screen movement is output at step S308. In some cases, the location and size of the sub-screen window are also automatically adjusted. After step S308, the procedure may end or proceed to S307. If it is determined that an internal adjustment is not needed, it is then determined whether the direction of camera is adjustable at step S307. Alternatively, step S307 can be performed after step S308 has been performed. If it is determined that the direction of camera is adjustable, the direction of camera is adjusted to obtain an optimum image based on the generated optimum disposition information at step S309.

Referring to FIG. 4, the sub-screen output controller 203 obtains an image configuring a sub-screen at step S401, and identifies or recognizes object disposition information of the image such as a type, size, location, number, and distribution of objects at step S402. Subsequently, optimum disposition information for providing a user with an optimum image is generated by comparing the identified object disposition information with predetermined basic disposition information at step S403. It is determined whether an internal adjustment through the implementation of the software is needed at step 404. If it is determined that the internal adjustment is needed, the sub-screen is adjusted based on the generated optimum disposition information by the internal adjustment (for example, a zooming-in function), or a guide for screen movement is output for a user at step S406. After step S406, the procedure may end or proceed to S405. If it is determined that the internal adjustment is not needed, it is then determined whether the direction of sub-camera is adjustable at step S405. Alternatively, step S405 can be performed after step S406 has been performed. If it is determined that the direction of sub-camera is adjustable, the direction of sub-camera is adjusted so that an optimum image can be obtained based on the generated optimum disposition information at step S407.

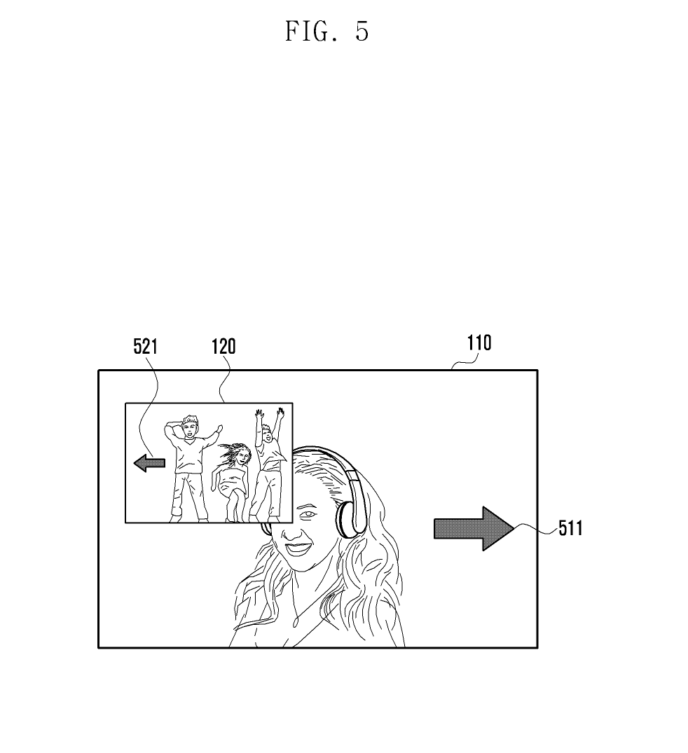

FIG. 5 is a screen example illustrating an operation of image processing device according to an embodiment of the present invention, when outputting first and second images respectively by including a sub-screen window 120 in a main screen 110.

For example, if a person image is included in the main screen 110 as an object and part of the person image is covered by the sub-screen window 120, a guide 511 directing a camera movement is output through the main screen so that the person image is not covered according to the basic disposition information. If one person image is output and the guide directs to locate the person image at the center, the main screen is configured not to cover the face of the person image by adjusting the size or location of the sub-screen window 120.

Further, if a plurality of person images is located at the right side of the sub-screen window 120, a guide 521 directing a camera movement is output on the sub-screen window so that the plurality of person images are located in the center according to the basic disposition information. The output screen shown in FIG. 5 is an example, and is not limited thereto.

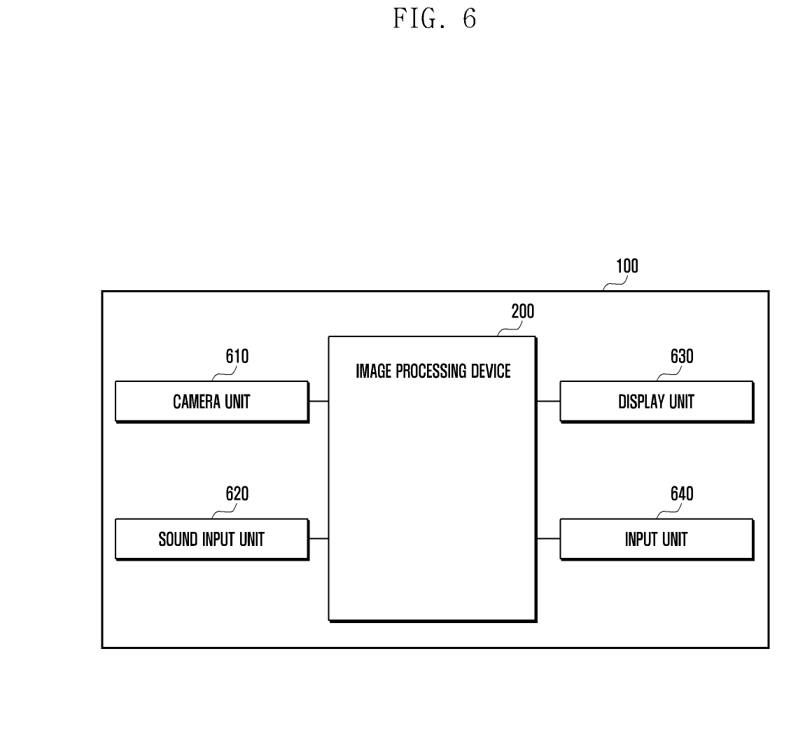

FIG. 6 is a block diagram illustrating a configuration of electronic device 100 including an image processing device 200 according to an embodiment of the present invention.

The electronic device 100 includes a camera unit 610, a sound input unit 620, a display unit 630, and an input unit 640 besides the image processor 200.

The camera unit 610 may include an image sensor and provide an image to the image processor 200 by obtaining the image through the image sensor.

The sound input unit 620 may include a microphone and a sound processor. The sound processor provides a function of tracing a sound from a plurality of sounds by using a sound tracing algorithm, inputs the only sound traced in the direction of sound, and removes noises by applying a sound beam forming technology to the sound traced according to the sound tracing algorithm. In this manner, the sound input unit 620 provides a clear sound input by increasing a Signal to Noise Ratio (SNR).

The sound input unit 620 according to an embodiment of the present invention receives a user sound by tracing the location of user in order to obtain an optimum image through the camera unit 610 while the electronic device 100 is moving, for example, while the location of user operating the electronic device 100 changes. According to an embodiment of the present invention, if optimum disposition information is generated for a user image input by the image processor 200, the sound input unit 620 applies the sound tracing function and sound beam forming technology based on the generated optimum disposition information.

The display unit 630 is a device for outputting information in the electronic device 100, and may include a display panel. The display unit 630 according to an embodiment of the present invention outputs images obtained by the camera unit 610 and various signals transmitted from the image processor 200.

The input unit 640 is a device for receiving a user input, and may include a sensor for detecting a user's touch input. A resistive type, capacitive type, electromagnetic induction type, pressure type, and various touch detection technologies may be applied to the input unit 640 according to an embodiment of the present invention.

The display unit 630 and the input unit 640 may be configured with a touch screen which simultaneously performs reception of touch input and display of contents.

The electronic device 100 according to an embodiment of the present invention outputs image signals input by the camera unit 610 through the display unit 630, and may be used for a camera preview, video recording, video telephone conversation, and video conference. Further, a voice may be received through the sound input unit 620 while an image is input by the camera unit 610.

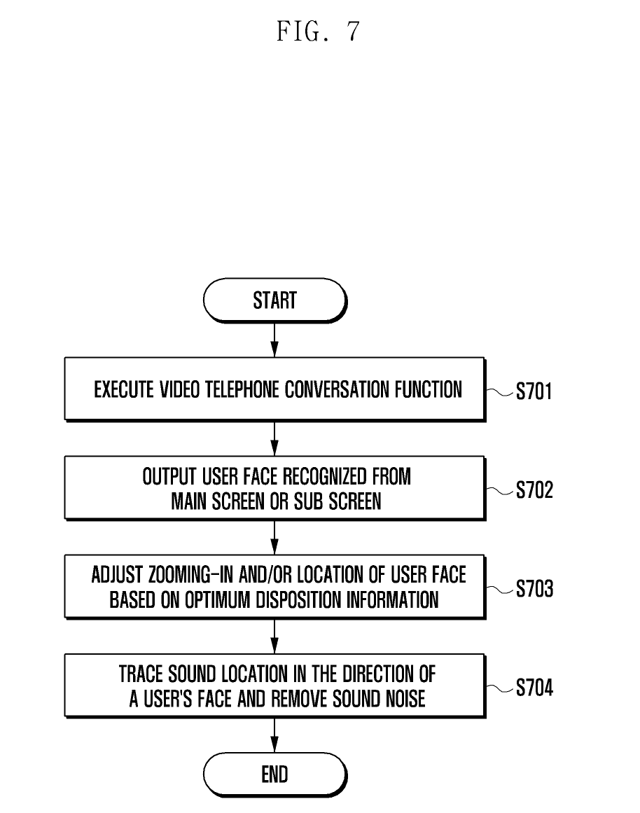

FIG. 7 is a flow chart illustrating a procedure of video telephone conversation in an electronic device 100 according to an embodiment of the present invention.

The electronic device 100 performs a video telephone conversation function at step S701. If the video telephone conversation is performed, an image of a user's face obtained by the camera unit 610 is displayed in a main screen or sub-screen of the display unit 630 at step S702. The image processor 200 generates optimum disposition information based on the disposition information of the obtained user's face image, and performs a zooming-in function so that an optimum user image can be obtained based on the optimum disposition information or outputs a guide for adjusting the location of user's face image in the screen at step S703.

Specifically, if an image is received from an image sensor in the camera unit 610, the image processor 200 stores the size, location, number of faces by converting image data transmitted from a face detector with an algorithm. The face detecting algorithm may be configured with a single algorithm or combination of various face detecting algorithms. The omega detector stores an estimated size, location, and number of heads by detecting each omega from the image data transmitted by the image sensor with an algorithm.

Resultant parameters stored by the face detector and omega detector are transmitted to a tracer. The tracer finally decides information such as the number and locations of heads included in the current image by using information transmitted by the face detector and omega detector and face and head information traced from a previous image. Therefore, the tracer decides more reliable information by combining with the face detector.

The image processor 200 collects parameters related to the size, location, and number of persons included in a face/omega-based screen based on the results received from the face detector, omega detector, and tracer. In such a way, complexity/distribution parameters in the screen are extracted, and optimum disposition information is generated by comparing the parameters with parameters of predetermined basic disposition information.

If the camera unit 610 of the electronic device 100 is movable, the movement of camera is controlled according to the optimum disposition information, and rotation or displacement of camera and up/down/right/left rotation or displacement of image sensor are performed. Further, parameter adjustment functions such as a zooming-in function of the camera are performed and a guide for movement of the electronic device 100 is output based on the optimum disposition information. If a new image is detected, the electronic device 100 newly starts the face detection and omega detection.

According to an embodiment of the present invention, the electronic device 100 may use the following algorithm to obtain an optimum image at step S703.

In an automatic video telephone conversation mode, users' faces or heads included in the current image are detected through the face detector and omega detector, and related disposition information (for example, size and location of detected area) is extracted. Here, detection of the head (mainly, side view or rear view) is performed through omega detector.

A step of re-adjusting user information is to determine whether an overlapped user area exists between the detected results of the face detector and omega detector. If the overlapped user area exists, the result of the face detector is accepted and the result of the omega detector is ignored.

If user information related to the re-adjustment of image exists, the user information is combined with user information of a previous image obtained by the tracer. If the user information doesn't exist, it is determined that a person doesn't exist in the current image.

If a specific area is touched or drawn on the screen according to an embodiment of the present invention, the touch or drawn area is used as a detected object, which is very useful when a face is not detected due to various reasons such as illumination, angle of face, and resolution.

Subsequently, the current image is identified whether it is suitable for being transmitted as a good image by comparing the disposition information with predetermined basic disposition information, and if the condition is satisfied, video telephone conversation is performed without adjusting the current image. If the condition is not satisfied, an operation of generating optimum disposition information is performed.

The current image may be stored, or a screen control of a mobile terminal may be changed by commanding a drive controller based on the transmitted contents.

If the camera unit 610 of the electronic device 100 is movable, the movement of camera is controlled based on the optimum disposition information, and rotation or displacement of camera and up/down/right/left rotation or displacement are performed. Further, parameter adjustment functions such as a zooming-in function of the camera are performed and a guide for movement of the electronic device 100 is output based on the optimum disposition information. If a new image is detected, the electronic device 100 newly starts the face detection and omega detection.

If an output image is adjusted at step S703 in the above-described various methods, the sound input unit 620 traces the location of sound in the direction of a user's face based on the optimum disposition information and removes noises of sound at step S704.

For example, the sound input unit 620 reduces noises and increases SNR by receiving only the sound in the direction of user's voice and applying the beam forming technology according to the optimum disposition information or the location of face adjusted on the screen, and thereby increases the accuracy of face detection and image processing by applying a sound location tracing algorithm to find out the location of the user. Further, the sound tracing technology is applied to a section identified as a voice by separating voice, non-voice, and bundle sections, and only the user's voice is extracted and transmitted by applying the sound location technology only to the sound having a specific length.

Major persons are extracted by using the optimum disposition information when a plurality of faces are shown in the screen, and more accurate sound tracing is enabled through dialogist identification and sound tracing of the major persons after removing noises from input sounds and separating voices of a plurality dialogists by applying the sound separation algorithm.

Alternatively, the location of persons is more accurately processed by detecting a touch input or movement through the input unit 640 and analyzing an input value of a sensor.

According to an embodiment of the present invention, if the electronic device 100 is a system launched with more than one camera, three-dimensional (3D) image can be configured by processing more than one image and thereby 3D video telephone conversation or video conference service can be provided by transmitting 3D user's face found from a voice or image.

According to an embodiment of the present invention, it is useful for a user to obtain an optimum image when capturing an image through a camera, and more particularly, each image can be provided in an optimum condition when a plurality of images is output though a screen.

Although embodiments of the present invention have been described in detail hereinabove, it should be understood that many variations and modifications of the basic inventive concept described herein will still fall within the spirit and scope of the present invention as defined in the appended claims and their equivalents.

What is claimed is:

1. A method for processing and outputting a first image and a second image respectively obtained from first and second image sensors in a screen, the method comprising:
recognizing first disposition information of at least one object included in the first image output through a main window;
identifying disposition information of a sub-window outputting the second image; and
generating optimum disposition information of the first image by comparing the first disposition information of the at least one object and the disposition information of the sub-window with predetermined basic disposition information, the optimum disposition information enabling an adjustment of a disposition of at least one of the first image and the sub-window.

2. The method of claim 1, wherein the screen is configured in a Picture In Picture (PIP) structure of which the sub-window is included in the main window.

3. The method of claim 1, wherein the first disposition information of the at least one object includes at least one of a type, size, occupation ratio, location, number, and distribution of the at least one object.

4. The method of claim 1, wherein the disposition information of the sub-window includes at least one of a location and size of the sub-window.

5. The method of claim 1, wherein generating optimum disposition information of the first image comprises:
extracting an object of the first image covered by the sub-windows based on the first disposition information of the at least one object and the disposition information of the sub-window;
identifying whether to generate the optimum disposition information by including the covered object of the first image; and
generating the optimum disposition information of the first image based on the first disposition information of the at least one object including the covered object of the first image or based on the first disposition information of the at least one object excluding the covered object of the first image according to the result of identifying.

6. The method of claim 1, further comprising at least one of:
adjusting the main window or outputting a first screen movement guide based on the optimum disposition information of the first image; and
adjusting at least one of a location and size of the sub-window based on the optimum disposition information of the first image.

7. The method of claim 1, further comprising:
adjusting a direction of the first image sensor based on the optimum disposition information of the first image.

8. The method of claim 1, further comprising:
identifying second disposition information of at least one object included in the second image output through the sub-window; and
generating optimum disposition information of the second image by comparing the second disposition information of the at least one object included in the second image with the predetermined basic disposition information.

9. The method of claim 8, further comprising:
adjusting the sub-window or outputting a second screen movement guide based on the optimum disposition information of the second image.

10. The method of claim 8, further comprising:
adjusting a direction of the second image sensor based on the optimum disposition information of the second image.

11. The method of claim 8, further comprising:
performing sound location tracing and sound noise removing functions based on the optimum disposition information of the first or second image.

12. A device for processing and outputting a first image and a second image respectively obtained from first and second image sensors in a screen, the device comprising:
a first image recognizer that identifies first disposition information of at least one object included in the first image output through a main window and disposition information of a sub-window outputting the second image; and
a first image processor that generates optimum disposition information by comparing the first disposition information of the at least one object included in the first image and the disposition information of the sub-window with predetermined basic disposition information, the optimum disposition information enabling an adjustment of a disposition of at least one of the first image and the sub-window.

13. The device of claim 12, wherein the sub-window is included in the main window in a Picture In Picture (PIP) form.

14. The device of claim 12, wherein the disposition information of the sub-window includes at least one of a location and size of the sub-window.

15. The device of claim 12, wherein the first image processor further extracts an object of the first image covered by the sub-window based on the first disposition information of the at least one object and the disposition information of the sub-window, identifies whether to generate the optimum disposition information by including the covered object of the first image, and generates optimum disposition information of the first image based on the first disposition information of the at least one object including the covered object of the first image or based on the disposition information of the at least one object excluding the covered object of the first image according to a result of the identifying.

16. The device of claim 12, further comprising:
a second image recognizer that identifies second disposition information of at least one object included in the second image output through the sub-window; and
a second image processor that generates optimum disposition information of the second image by comparing the second disposition information of the at least one object included in the second image with the predetermined basic disposition information.

17. The device of claim 16, wherein the first and second disposition information of the at least one object included in the first and second images respectively include at least one of a type, size, occupation ratio, location, number, and distribution of the at least one object included in the first and second images.

18. The device of claim 16, further comprising:
a first output controller that adjusts the main window or outputs a first screen movement guide based on the optimum disposition information of the first image; and
a second output controller that adjusts the sub-window or outputs a second screen movement guide based on the optimum disposition information of the second image.

19. The device of claim 16, further comprising:
a first image sensor adjuster that adjusts a direction of the first image sensor based on the optimum disposition information of the first image; and
a second image sensor adjuster that adjusts a direction of the second image sensor based on the optimum disposition information of the second image.

20. The device of claim 16, further comprising:
a sound input unit that performs sound location tracing and sound noise removing functions based on the optimum disposition information of the first or second image.
